(19) United States
(12) Patent Application Publication
(10) Pub. No.: US 2010/0289623 A1
(43) Pub. Date: Nov. 18, 2010

(54) INTERROGATING RADIO FREQUENCY IDENTIFICATION (RFID) TAGS

(76) Inventor: Bruce B. Roesner, Durham, NC (US)

Correspondence Address: FISH & RICHARDSON P.C., P.O. BOX 1022, MINNEAPOLIS, MN, 55440-1022, US

(21) Appl. No.: 12/465,516

(22) Filed: May 13, 2009

(51) Int. Cl. G06K 7/01

(52) U.S. Cl. 340/10.3

(57) ABSTRACT

The present disclosure is directed to a system and method for interrogating RFID tags. In some implementations, a method includes transmitting an RF command signal to RFID tags in an inhibited zone during a first time period. The RF command signal substantially prevents the RFID tags in the inhibited zone from responding to RF interrogation. RFID tags in a target zone are interrogated during a second time period different from the first time period. The target zone located differently from the inhibited zone.

### TECHNICAL FIELD

This application relates to detecting Radio Frequency (RF) signals and, more particularly, interrogating RF identification (RFID) tags.

### BACKGROUND

In some cases, an RFID reader operates in a dense reader environment, i.e., an area with many readers sharing fewer channels than the number of readers. Each RFID reader works to scan its interrogation zone for transponders, reading them when they are found. Because the transponder uses radar cross section (RCS) modulation to backscatter information to the readers, the RFID communications link can be very asymmetric. The readers typically transmit around 1 watt, while only about 0.1 milliwatt or less gets reflected back from the transponder. After propagation losses from the transponder to the reader the receive signal power at the reader can be 1 nanowatt for fully passive transponders, and as low as 1 picowatt for battery assisted transponders. At the same time other nearby readers also transmit 1 watt, sometimes on the same channel or nearby channels. Although the transponder backscatter signal is, in some cases, separated from the readers' transmission on a sub-carrier, the problem of filtering out unwanted adjacent reader transmissions is very difficult.

### SUMMARY

The present disclosure is directed to a system and method for interrogating RFID tags. In some implementations, a method includes transmitting an RF command signal to RFID tags in an inhibited zone during a first time period. The RF command signal substantially prevents the RFID tags in the inhibited zone from responding to RF interrogation. RFID tags in a target zone arc interrogated during a second time period different from the first time period. The target zone located differently from the inhibited zone. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an example system for selectively interrogating RFID tags in accordance with some implementations of the present disclosure;

FIG. 2 illustrates an example interrogation system of FIG. 1 in accordance with some implementations of the present disclosure;

FIG. 3 illustrates an example system including multiple inhibited zones associated with interrogating RFID tags;

FIG. 4 illustrates another example system for selectively interrogating RFID tags in accordance with some implementations of the present disclosure; and

FIG. 5 is a flow chart illustrating an example method for interrogating RFID tags in a field of interest.

Like reference symbols in the various drawings indicate like elements.

### DETAILED DESCRIPTION

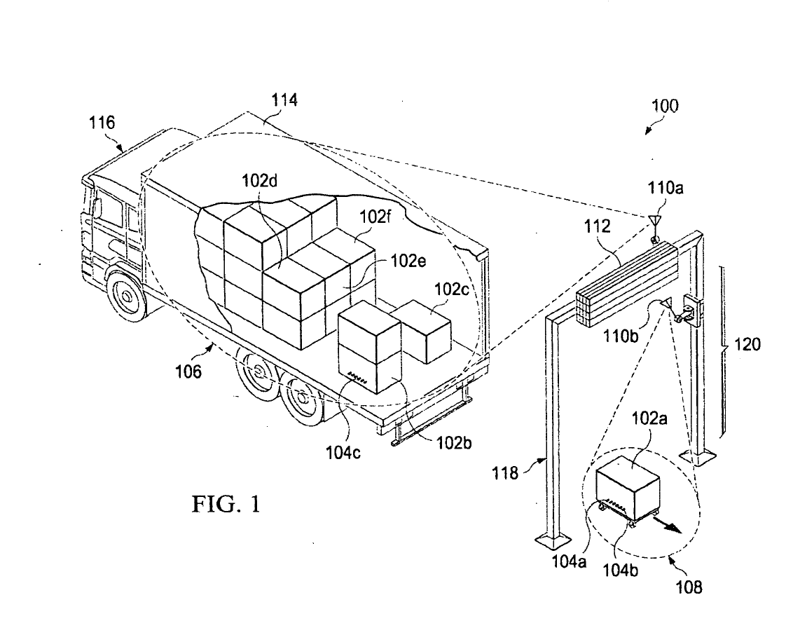

FIG. 1 illustrates an example system 100 for selectively interrogating one or more Radio Frequency Identification (RFID) tags in accordance with some implementations of the present disclosure. For example, the system 100 may interrogate RFID tags in a target zone and prevent or otherwise inhibit RFID tags in an inhibited zone from responding to interrogations. The target zone may include a space or volume that includes RFID tags interrogated by the system 100. The inhibited zone may include a space or volume that includes RFID tags substantially excluded from interrogation. For example, the tags in the target zone may include those being shipped to a different location while the tags in the inhibited zones may include those remaining at a current location. In some implementations, the system may execute one or more of the following: identify a first time period associated with one or more inhibited zones; transmit one or more commands to the inhibit zones to switch the included tags to an unresponsive state; identify a second time period associated with one or more target zones; transmit requests for information to those tags in the target zone; switch between transmitting idle commands and interrogation request based on a request and/or schedule; and/or other processes. In some implementations, the system 100 can update or maintain the unresponsive states in the inhibited zone to enhance, maximize, or otherwise increase read accuracy of those RFID tags in the target zone. For example, the system 100 may periodically transmit commands to RFID tags in the inhibited zone to maintain or update to the unresponsive states to substantially prevent the system 100 from receiving interrogation responses from tags inside the inhibited zone.

At a high level, the system 100, in some implementations, includes pallets 102a-i containing, including, or otherwise transporting RFID tags 104. The pallet 102 can, in some implementations, include several hundred tags 104. The RFID tags 104 are communicatively coupled to an RFID reader 106 through an inhibited zone 106 or a target zone 108 using antennas 110a or 110b connected to a reader 112. The system 100 may include more or less than two antennas (e g., 4, 6) to communicate with the tags 104 without departing from the scope of this disclosure. In addition, the antennas 110 may be in any number of configurations and orientations such as left and right, up and down, and/or others. From a high level of operation, the reader 112 may selectively switch between the antennas 110a and 110b. During a first time period, the reader 112 may transmit commands to the inhibited zone 106 using the antenna 110b to maintain or switch those tags 104 to an idle state. During a second time period, the reader 112 may interrogate tags 104 in the target zone 108 for information associated with the responding tags 104. The RFID tags 104 may move through the target zone 108 at a certain rate (e.g., 1.5 m/s). The pallet 102 generally moves at a rate between 1 meter per second (m/s) to 2 m/s. The RFID reader 106 transmits queries and/or commands using the antenna 110b to the moving tags 104 in the target zone 108. As the pallet 102 moves through the interrogation zone 108, the RFID tags 104 may respond to received queries and/or commands. For example, the RFID tags 104 may transmit information including associated identifiers to the RFID reader 106. By inhibiting or otherwise updating tags 104 in the inhibited zone 106 to an idle or unresponsive state, the system 100 eliminates, minimizes, or otherwise reduces interrogation replies from those tags 104 in the inhibited zone 106. In other words, the inhibited zone 106 may increase the accuracy or reading tags 104 in the target zone 108. Although the system 100 illustrates a supply chain pallet and dock door portal, the system 100 may be equally applicable to manufacturing conveyor belts, automatic vehicle identification systems, retail stores, and/or others.

Turning to a more detailed description of some implementations of the system 100, the RFID tags 104 can include any software, hardware, and/or firmware configured to respond to communication from the RFID reader 108. These tags 104 may operate without the use of an internal power supply. Rather, the tags 104 may transmit a reply using power stored from the previously received RF signals, independent of an internal power source. This mode of operation is typically referred to as backscattering. In some implementations, the tags 104 alternate between absorbing power from signals transmitted by the RFID reader 108 and transmitting responses to the signals using at least a portion of the absorbed power. In passive tag operation, the tags 104 typically have a maximum allowable time to maintain at least a minimum DC voltage level. In some implementations, this time duration is determined by the amount of power available from an antenna of a tag 104 minus the power consumed by the tag 104 and the size of the on-chip capacitance. The effective capacitance can, in some implementations, be configured to store sufficient power to support the internal DC voltage when there is no received RF power available via the antenna. The tag 104 may consume the stored power when information is either transmitted to the tag 104 or the tag 104 responds to the RFID reader 108 (e.g., modulated signal on the antenna input). In transmitting responses back to the RFID reader 108, the tags 104 may include one or more of the following: an identification string, locally stored data, tag status, internal temperature, and/or others. For example, the tag 104 may transmit information including or otherwise identifying vehicle information such as type, weight, vehicle height, tag height, account number, owner information (e.g., name, license number), and/or other information. In some implementations, the signals can be based, at least in part, on sinusoids having frequencies in the range of 902-928 MHz or 2400-2483.5 MHz. In some implementations, an RFID tag 104 in the inhibited zone may be of a type manufactured to support the ISO 18000-6C standard. An RFID tag manufactured to ISO 18000-6C standard may support dual states: an A state, in which the RFID tag is responsive to RF interrogation, and a B state, in which the RFID tag is temporarily unresponsive to RF interrogation. Under the ISO 18000-6C standard, an RFID tag may typically remain in an unresponsive B state for between 0.8 seconds and 2.0 seconds even without any further power being supplied to the RFID tag 104.

The RFID reader 112 can include any software, hardware, and/or firmware configured to transmit and receive RF signals. In general, the RFID reader 112 may transmit request for information within a certain geographic area, or interrogation zone, associated with the reader 112. The reader 112 may transmit the query in response to a request, automatically, in response to a threshold being satisfied (e.g., expiration of time), as well as others events. The interrogation zone may be based on one or more parameters such as transmission power, associated protocol, nearby impediments (e.g., objects, walls, buildings), as well as others. In general, the RFID reader 112 may include a controller, a transceiver coupled to the controller (not illustrated), and at least one RF antenna 142 coupled to the transceiver. In the illustrated example, the RF antenna 142 transmits commands generated by the controller through the transceiver and receives responses from RFID tags 130 and/or energy transfer media 120 in the associated interrogation zone. In certain cases such as tag-talks-first (TTF) systems, the reader 112 may not transmit commands but only RF energy. In some implementations, the controller can determine statistical data based, at least in part, on tag responses. The readers 140 often includes a power supply or may obtain power from a coupled source for powering included elements and transmitting signals. In some implementations, the reader 112 operates in one or more of frequency bands allotted for RF communication. For example, the Federal Communication Commission (FCC) have assigned 902-928 MHz and 2400-2483.5 MHz as frequency bands for certain RFID applications. In some implementations, the reader 112 may dynamically switch between different frequency bands. For example, the reader 112 may switch between European bands 860 to 870 MHz and Japanese frequency bands 952 MHz to 956 MHz. Some implementations of system 100 may further include an RFID reader 112 to control timing, coordination, synchronization, and/or signal strength of transmissions by inhibitor antenna 110a and RFID antenna 110b. Some implementations may also include a frame or other structural support on which at least one of inhibitor antenna 110a, RFID antenna 110b, and/or RFID reader 112 arc suspended or otherwise attached.

In some aspects of operation, the system 100 may initially define, generate or otherwise identify an inhibited zone 106 substantially preventing interrogation of include tags 104 and a target zone 108 for interrogating included tags 104. As illustrated, the inhibited zone 106 includes at least a portion of a trailer 114 of a delivery vehicle 116. For example, the vehicle 116 may be delivering the pallets 102 to, for example, a warehouse, retailer, and/or other facility. The antenna 110a may transmit commands to the inhibited zone 106 to place, maintain, or update states of the tags 104 in the trailer 114 to idle states or states that do not reply to interrogation requests. For example, the reader 112 may establish the inhibited zone 106 by transmitting, from an inhibitor antenna 110a, an RF command signal substantially preventing RFID tags 104 from responding to RF interrogation. The reader 112 may generate the target zone 108 by transmitting RF interrogation signals from an RFID antenna 110b directed to the portal 118. In some implementations, the system 100 may be used to distinguish RFID tags 104 in a field of interest (e.g., target zone 108) from RFID tags 104 in a field of disinterest (e.g., inhibited zone 106). For example, many goods distributed via modern supply chains are associated with an RFID tag 104 for more efficient identification and/or inventorying. Individual goods in transit may each be associated and packaged with at least one individual RFID tag 104. Individual goods may in turn be grouped and packaged so that multiple goods, each associated with different RFID tags 104, share a single package, container, box, or pallet. At various checkpoints in a supply chain, certain goods and/or pallets of goods may be identified, tracked, and/or inventoried by RFID interrogation to the exclusion of other goods with which they may be in close physical proximity. As previously mentioned, the system 100 may be used to interrogate one or more RFID tags 104 associated with goods packaged on a pallet 102 after unloading it from a delivery vehicle 116. In some implementations, the system 100 may be used to interrogate one or more RFID tags 104 associated with goods packaged on pallet 104 prior to loading it into the delivery vehicle 116. In either case, the system 100 may be configured to identify RFID tags 104 associated with goods in the target zone 108 while minimizing, eliminating, or reducing unintentional identification of RFID tags 104 associated with other goods in the inhibited zone 106.

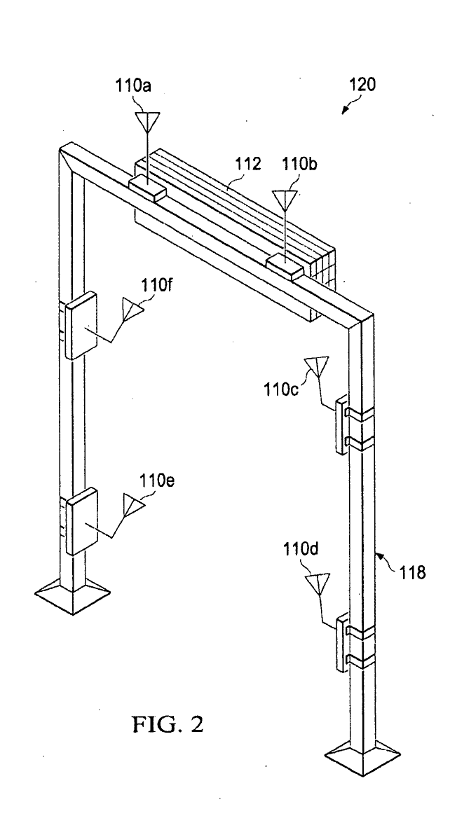

FIG. 2 illustrates an antenna system 200 including a plurality of antennas 110a-f for selectively interrogating RFID tags. For example, the antennas 110a and 110b may be inhibitor antennas that transmit commands to update tag states to substantially prevent interrogation of those tags, and the antennas 110c-f may be interrogation antennas that interrogation tags passing through the portal 118. Positioning and/or arrangement of the inhibitor antennas 110a and 110b may be application specific. For example, the inhibitor antennas 110a and 110b may generate an inhibited zone 106 of FIG. 1 in a volume of space from which unintended interrogation of RFID tags 104 may be anticipated. In some implementations, system 100 may be used at a supply chain checkpoint or staging area. Regardless, the inhibitor antennas 110a and 110b may be oriented in such a way that an RFID command signal may be transmitted to RFID tags 104 not currently intended to be interrogated, which may otherwise be unintentionally interrogated by the RFID antennas 110c-f due to, for example, their proximity to the portal 118 and/or the geometry and/or arrangement of RF-reflective materials in the local environment (e.g., a freight bed or trailer 114, walls or ceiling of a warehouse, fluorescent lighting fixtures, other objects). In some implementations inhibitor antennas 110a and 110b may also be arranged in various positions relative to each other. Consideration for generating an appropriately oriented inhibited zone 106 may dictate the relative positions, angles, and geometry of inhibitor antennas 110a and 110b with respect to each other and a local environment.

In some implementations system 100 may include an array of RFID antennas 110c-f In some implementations RFID antennas 110c-f may be arranged in various positions relative to each other. The arrangement of RFID antennas 110c-f as shown in FIG. 2 is for example purposes only, and the antenna system 200 may include some, none, or all aspects of the illustrated array without departing from the scope of the disclosure. In some implementations a height of RFID antennas 110c-f above ground level may differ with respect to each other in the array. In some implementations, the RFID antennas 110c-f may not mirror the relative position, geometry, or angles of any of the other RFID antennas in the array. Relative positions, angles, and geometry of RFID antennas 110c-f may vary with respect to each other and/or the local environment.

In some implementations, the RFID antennas 110c-f may be arranged in an attempt to maximize or otherwise increase effective interrogation of RFID tags in a target zone. The Antenna configuration may be based, at least in part, the specific packaging and/or arrangement of goods passing through a target zone. For example, certain pallets, boxes, crates, or packages of goods passing through a target zone may include stacked containers with RFID tags, as well as layers of RF-absorptive material (e.g., water) which may attenuate RF signals and interfere with RF interrogation of RFID tags within the pallet. Such containers may be arranged in such a way that not all RFID tags are located near the periphery of the pallet, box, crate, or package, further interfering with interrogation of RFID tags within. The RFID antennas 110c-f may be independently oriented to increase RFID interrogation within the target zone.

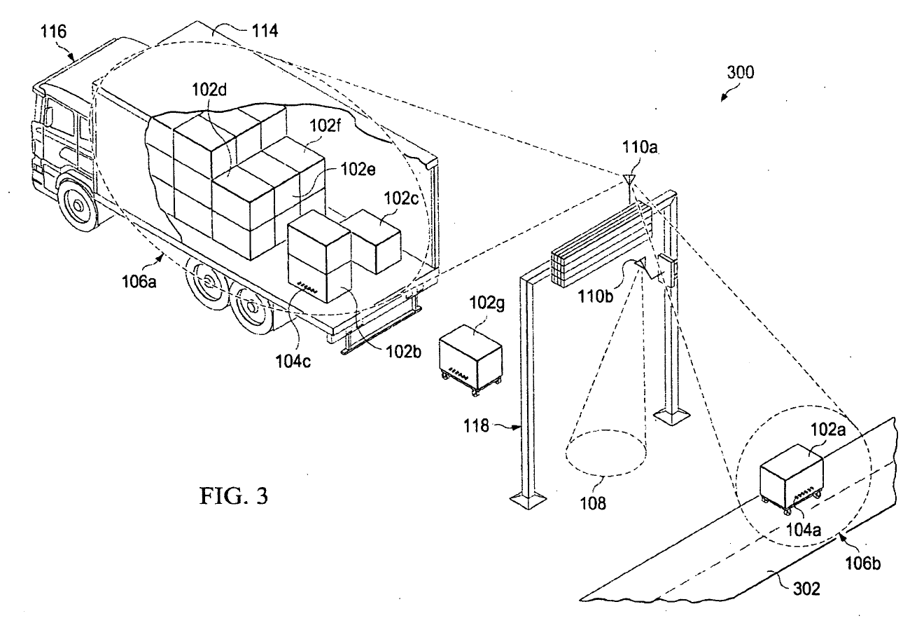

FIG. 3 illustrates the system 300 including a plurality of inhibited zones 106. In the illustrated implementation, the system 300 generates inhibited zones 106 that envelops or otherwise overlaps RFID tags 104 in the trailer 114 of the delivery vehicle 116 and tags 104 in the warehouse 302. The inhibited zones 106 may be established by transmitting, from one or more inhibitor antennas 110a, an RF command signal substantially preventing RFID tags 102 from responding to RF interrogation or received requests.

In some implementations, the system 300 may simultaneously generate inhibited zones 106a and 106b by transmitting, from inhibitor antenna 110a, an RF command signal substantially preventing RFID tags 312 from responding to RF interrogation. In some case, the system 300 may have an inhibitor antenna 110a for each zone 106 and/or the antenna 110a may switch between transmitting RF commands to the zones 106. The orientation of inhibited zones 106 may be application specific and may depend in part on generating one or more inhibited zones 106 in a volume of space from which unintended interrogation of RFID tag 102 may be identified and/or anticipated. For example, the system 300 may be used at a supply chain checkpoint or staging area and unintended interrogation of RFID tags 104 may be anticipated due to proximity to an interrogation zone 108 and/or the geometry and arrangement of RF-reflective materials in tile local environment. In some implementations, the RFID tags 104 may pass through a lane, walkway, or pathway commonly used for transportation of goods at a supply chain checkpoint and in relative proximity to the interrogation zone 108.

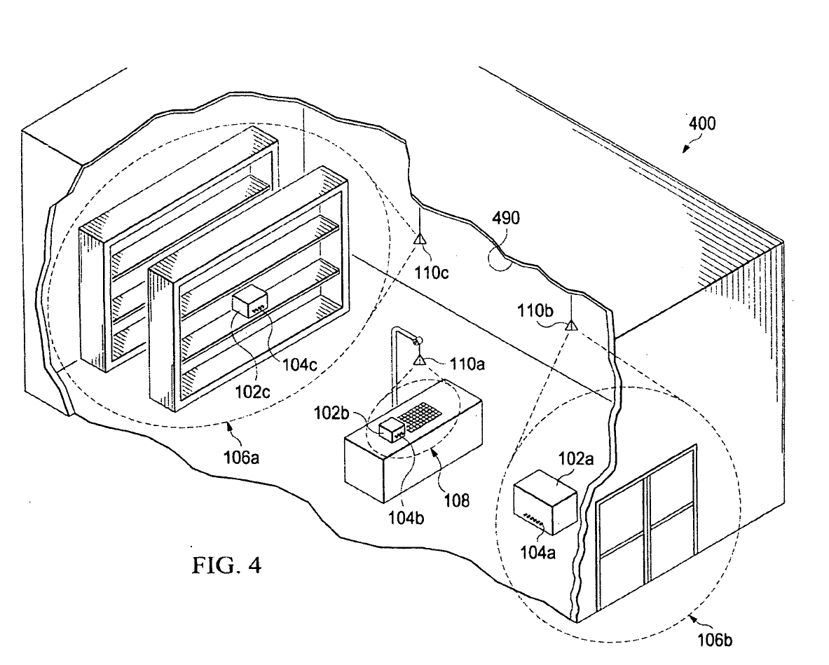

FIG. 4 illustrates that a retail system 400 that includes a plurality of inhibited zones 106 in a retail environment. For example, the system 400 may be used to distinguish RFID tags 104 affixed to or otherwise associated with goods to be purchased in a checkout area 402 of a retail store from RFID tags 104 associated with inventory goods in inhibited zone 106a and RFID tags 104 associated with previously purchased goods in inhibited zone 106b. Inhibitor antennas 110b and 110b may be affixed to a ceiling surface 404, walls (not shown), and/or other support (not shown) and may be oriented so as to transmit RF signals to zones 106a and 106b. The orientation of inhibitor antennas 110a and 110b may be application specific, based, at least in part, on one or more aspects of the retail environment (e.g., wall surfaces, proximity of zones). In some implementations, antenna 115 and antenna 215 may each consist of an array of inhibitor antennas. In some implementations, the functionality of RFID reader may be distributed between two or more RFID readers. For example, one or more RFID readers (not illustrated in FIG. 2) may control inhibitor antennas 110b and 110c, while another RFID reader (also not illustrated in FIG. 2) may control RFID antenna 110a.

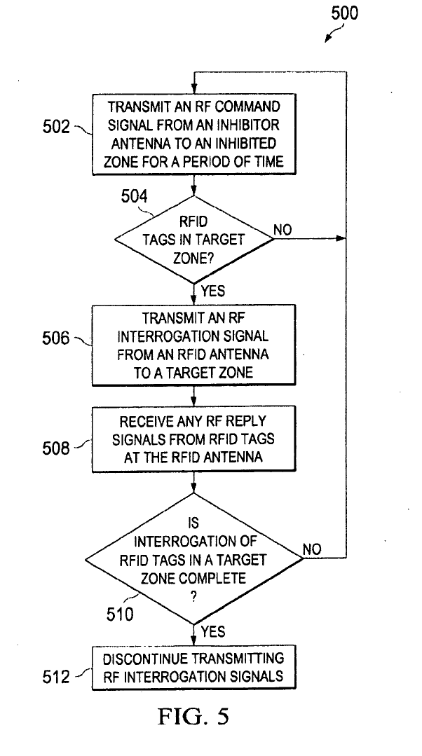

FIG. 5 is a flowchart illustrating an example method 500 for inhibiting RFID tags in one or more locations to substantially prevent interrogation of those tags. Generally, the method 500 describe example techniques for substantially preventing interrogation of RFID tags. In particular, the method 500 describes periodically transmitting RFID commands to certain areas or zones to switch or maintain tags in a non-responsive state. The reader 112 may use any appropriate combination and arrangement of logical elements implementing some or all of the described functionality.

The method 500 begins at step 502 where with transmitting an RF command signal from an inhibitor antenna to an inhibited zone. For example, the reader 112 may transmit the RFID command for about 10 milliseconds. In some implementations, the RFID tags 104 can be manufactured according to the ISO 18000-6C standard, and tags 104 in the inhibited zone 106 may receive the RFID command signal to enter a B state. In these implementations, the RFID tags 104 can be temporarily unresponsive to RF interrogation. Such an ISO 18000-6C standard RFID tag may enter a temporarily unresponsive B state after approximately 5 milliseconds of exposure to the RFID command signal. If RFID tags are not in the interrogation zone at decisional step 502, then execution returns to step 502 where, for example, an RF command signal may be transmitted to an inhibited zone for a period of about 10 milliseconds. In some implementations, the period for transmitting RF commands and the period for interrogating tags are different and may not overlap. If RFID tags are in the interrogation zone at decisional step 504, then, at step 506, an RFID interrogation signal is transmitted to a target zone. In the example, the reader 112 may automatically switch between interrogating tags 102 and transmitting commands to the inhibited zones 106 independent of detecting tags 102 in the target zone 108. At step 506, RF reply signals may be received. Again in the example, starting immediately after initiation of the interrogation and for a period of 400 milliseconds thereafter, the reader 112 may receive reply signals from tags 102 in the interrogation zone 108. Accuracy may be improved because some nominally ISO 18000-6C-compliant RFID tags may take longer than a typical 5 millisecond command signal exposure in order to enter a B state; and certain other ISO 18000-6C RFID tags may require longer than typical exposure times before entering a B state due to command signal power attenuation based on a local RF environment. 30 Moreover, accuracy of RFID interrogation at the RFID antenna may be further improved by discontinuing RF reception of reply signals at the RFID antenna 400 milliseconds after initiating transmission of the interrogation signal because some nominally ISO 18000-6C-compliant RFID tags may stay in non-responsive state B for less than the typical 0.8-2.0 seconds and reenter a state A responsive to RFID interrogation sooner than anticipated based on the ISO 18000-6C standard. If interrogation of the RFID tags is not complete at decisional step 510, then execution returns to step 502. If interrogation of the RFID tags is complete, then, at step 512, transmission of the interrogation signal is discontinued.

A number of embodiments of the invention have been described. Nevertheless, it will be understood that various modifications may be made without departing from the spirit and scope of the invention. Accordingly, other embodiments are within the scope of the following claims.

What is claimed is:

1. A system for identifying RFID tags, comprising:
an inhibitor antenna configured to transmit an RF command signal to RFID tags in an inhibited zone, the RF command signal substantially preventing the RFID tags in the inhibited zone from responding to RF interrogation;
an interrogation RFID antenna for interrogating RFID tags in a target zone, the target zone located differently from the inhibited zone; and
an RFID reader that selectively switches between transmitting the RF command signal to the inhibited zone and interrogating the RFID tags in the target zone.

2. The system of claim 1, wherein at least one of the inhibitor antenna or the interrogation RFID antenna is a 9 dBic antenna.

3. The system of claim 1, further comprising a plurality of inhibitor antennas, including the inhibitor antenna, transmitting to a plurality of inhibited zones, including the target zone, the RF command signal.

4. The system of claim 1, wherein at least one of the RFID tags in the inhibited zone or the RFID tags in the target zone are ISO 18000-6C standard compliant.

5. The system of claim 1, the RF command signal switches the RFID tags in the target zone to an unresponsive state for a period of time.

6. The system of claim 1, the inhibitor antenna transmits the RF command signal at a period of 0.8 seconds or less.

7. The system of claim 1, further comprising a plurality of interrogation antennas including the interrogation antenna and each arranged at different heights.

8. The system of claim 1, the target zone located from the inhibited zone in range from eight to twelve feet.

9. The system of claim 1, wherein the reader comprises a first RFID reader, further comprising a second RFID reader synchronized with the first RFID reader to selectively switch between transmissions from the inhibitor antenna and transmissions from the interrogation antenna.

10. A method for identifying RFID tags, comprising:
transmitting an RF command signal to RFID tags in an inhibited zone during a first time period, the first RF command signal substantially preventing the RFID tags in the inhibited zone from responding to RF interrogation; and
interrogating RFID tags in a target zone during a second time period different from the first time period, the target zone located differently from the inhibited zone.

11. The method of claim 10, at least one of the RF command signal or the interrogation is transmitted using a 9 dBic antenna.

12. The method of claim 10, further comprising transmitting the RF command to a plurality of inhibited zones, including the inhibited zone.

13. The method of claim 10, wherein at least one of the RFID tags in the inhibited zone or the RFID tags in the target zone are ISO 18000-6C standard compliant.

14. The method of claim 10, the RF command signal switches the RFID tags in the target zone to an unresponsive state for a period of time.

15. The method of claim 10, the RF command signal transmitted at a period of 0.8 seconds or less.

16. The method of claim 10, further comprising interrogating a plurality of target zones, including the target zone, using a plurality of interrogation antennas at different heights.

17. The method of claim 10, the target zone located from the inhibited zone in a range from eight to twelve feet.

18. The method of claim 10, the RF command signal transmitted for a duration of at least 10 milliseconds.

19. A system for identifying RFID tags, comprising:
a plurality of inhibitor antennas configured to transmit an RF command signal to RFID tags in a plurality of different inhibited zone, the RF command signal substantially prevents the RI--ID tags in the plurality of inhibited zones from responding to RF interrogation;
a first RFID reader that periodically transmits the RF command signal using the plurality of antennas;
an interrogation RFID antenna for interrogating RFID tags in a target zone, the target zone located differently from the inhibited zone; and
a second RFID reader that transmits interrogation request to the target zone using the interrogation RFID antenna and synchronized with the first RFID reader.

20. The system of claim 19, the RF command transmitted for a period different from a period for interrogating the target zone.
